(19) United States
(12) Patent Application Publication
(10) Pub. No.: US 2014/0092430 A1
(43) Pub. Date: Apr. 3, 2014

(54) OPERATION DEVICE, OPERATION METHOD, AND IMAGE FORMING APPARATUS INCLUDING AN OPERATION DEVICE

(71) Applicant: KYOCERA Document Solutions Inc., Osaka (JP)

(72) Inventor: Koji Maeda, Osaka (JP)

(73) Assignee: KYOCERA Document Solutions Inc., Osaka (JP)

(21) Appl. No.: 14/031,190

(22) Filed: Sep. 19, 2013

(30) Foreign Application Priority Data
Sep. 28, 2012 (JP) 2012-215939

(51) Int. Cl. H04N 1/00

(52) U.S. Cl. CPC H04N 1/00411; H04N 1/00424
USPC 358/1.15

(57) ABSTRACT

An operation device that displays a predetermined number of item keys among plural item keys on a predetermined screen so as to be enabled to be pressed down, includes: a determining unit configured to determine whether or not pressing down a display switching key to switch currently displayed item keys on the screen and display item keys that have not been displayed on the screen is successive pushes when the display switching key is pressed down; and a displaying-receiving unit configured to display a list of a larger number of item keys that have not been displayed on the screen than a number that has been set to the screen so as to be enabled to be pressed down if the determining unit determines that pressing down the display switching key is successive pushes.

### CROSS-REFERENCE TO RELATED APPLICATIONS

This application relates to and claims priority rights from a Japanese Patent Application No. 2012-215939, filed on Sep. 28, 2012, the entire disclosures of which are hereby incorporated by reference herein.

### BACKGROUND

1. Field of the Present Disclosure

The present disclosure relates to an operation device, an operation method, and an image forming apparatus including an operation device.

2. Description of the Related Art

In general, an electrophotography image forming apparatus of such as a copier, a printer, or an MFP (Multi Function Peripheral) having functions thereof reads optically image data from an image on a document and has a printing function, a facsimile function, and other image data processing functions. The printing function performs printing by transferring and fixing a toner image based on the image data on a paper sheet. The facsimile function transmits and receives the image data by facsimile.

The image forming apparatus displays action statuses of the functions on an operation panel unit as a screen displaying unit arranged on a main body of the apparatus, and selects and performs a function according to a selecting operation to the operation panel unit. Further, the image forming apparatus performs display switching control of a displayed screen using a CPU (Central Processing Unit).

Recently, to gain commodity value of an image forming apparatus, in a market an image forming apparatus appears which has a so-called animation drawing function to generate plural partial screens of a next screen that gradually expand a displayed area from a corner part of the next screen in turn and draw the whole next screen after drawing the plural partial screens in turn, for example, with a time interval of 1 second when switching to the next screen on the operation panel unit. Consequently, a display performance is gained.

However, in the aforementioned animation drawing function, a user operation to the operation panel unit can not be received during the animation display action until the whole next screen is drawn in one or a few seconds, and therefore a user must wait for finishing the animation display action and drawing the whole next screen for a next operation to the operation panel unit.

In addition, a user familiar with operation of the image forming apparatus can not perform a next operation when the user wants to do it, and consequently it decreases user convenience.

In particular, in a configuration that a common CPU performs display control of the operation panel unit and print control and so forth, it is expected that the animation display action can not be performed in a short time, and therefore, improvement of it is desired.

To solve such a problem, a display control apparatus includes a screen displaying unit that visually displays action statuses of a device processing image data on a screen; an operation unit that at least changes a display status of the screen displaying unit; and a screen storing unit that stores screen data of each screen displayed on the screen displaying unit. Further, the display control apparatus includes a control unit. When a displayed screen is switched on the screen displaying unit, the control unit generates plural partial screens of a next screen that gradually expand a displayed area from a corner part of the next screen in turn and performs animation display control to display the whole next screen after displaying the plural partial screens in turn; and controls to cancel animation displaying and display the whole next screen if input is detected from the operation unit while animation displaying. It is described that therefore it is easy to realize the animation drawing function and swift operability of the apparatus.

Further, an input device includes a displaying unit that displays plural input keys; a touch panel that detects input to the plural input keys displayed on the displaying unit; and a detecting unit that detects successive pushes to the touch panel. The successive pushes are successive inputs with a time interval shorter than a predetermined time. The input device further includes a memory unit that memorizes an input key corresponding to a position where successive pushes start; and a control unit that controls so as to process an input in a preset predetermined area that includes the input key corresponding to the position where the successive pushes start as an input to the input key memorized by the memory unit, when the detecting unit detects the successive pushes to the touch panel. It is described that therefore it is possible to process user inputs as inputs to a key that a user initially intended even if a position where the user presses down is deviated when the user performs input operation to successively press down a same input key plural times (i.e. successive pushes).

Meanwhile, the number of selection item keys corresponding to predetermined functions, properties, and parameters tends to increase with recent higher machine performance.

On the other hand, all of the selection item keys can not be displayed due to a design of a touch panel that displays the selection item key such as the size of the touch panel or its screen design, and therefore it is configured so as to display plural screens one by one, of which each one includes a predetermined number of the selection item keys. In such a configuration, a user switches the screen by pressing down a display switching key that has been arranged, and looks for a selection item key which the user desires.

However, in the aforementioned configuration a problem arises which if the selection item key which the user desires is located in the last screen the user must press down the display switching key plural times and consequently it causes user's irritation and inconvenience. In addition, in the aforementioned configuration a problem arises which a user can not find the selection item key which the user desires efficiently. The aforementioned configurations can not solve the aforementioned problems.

### SUMMARY

An operation device according to an aspect of the present disclosure includes: a determining unit configured to determine whether or not pressing down a display switching key to switch currently displayed item keys on the screen and display item keys that have not been displayed on the screen is successive pushes when the display switching key is pressed down; and a displaying-receiving unit configured to display a list of a larger number of item keys that have not been displayed on the screen than a number that has been set to the screen so as to be enabled to be pressed down if the determining unit determines that pressing down the display switching key is successive pushes.

An image forming apparatus according to an aspect of the present disclosure includes an operation device. The operation device includes: a determining unit configured to determine whether or not pressing down a display switching key to switch currently displayed item keys on the screen and display item keys that have not been displayed on the screen is successive pushes when the display switching key is pressed down; and a displaying-receiving unit configured to display a list of a larger number of item keys that have not been displayed on the screen than a number that has been set to the screen so as to be enabled to be pressed down if the determining unit determines that pressing down the display switching key is successive pushes.

An operation method according to an aspect of the present disclosure includes the steps of: determining whether or not pressing down a display switching key to switch currently displayed item keys on the screen and display item keys that have not been displayed on the screen is successive pushes when the display switching key is pressed down; and displaying a list of a larger number of item keys that have not been displayed on the screen than a number that has been set to the screen so as to be enabled to be pressed down if it is determined that pressing down the display switching key is successive pushes.

A non-transitory computer readable recording medium according to an aspect of the present disclosure, storing a program that causes a computer to execute the steps of: determining whether or not pressing down a display switching key to switch currently displayed item keys on the screen and display item keys that have not been displayed on the screen is successive pushes when the display switching key is pressed down; and displaying a list of a larger number of item keys that have not been displayed on the screen than a number that has been set to the screen so as to be enabled to be pressed down if it is determined that pressing down the display switching key is successive pushes.

These and other objects, features and advantages of the present disclosure will become more apparent upon reading of the following detailed description along with the accompanied drawings.

### BRIEF DESCRIPTION OF THE DRAWINGS

FIG. 1 shows a schematic diagram which indicates a whole internal configuration of a multi function peripheral according to an embodiment of the present disclosure;

FIG. 2 shows a diagram which indicates a whole configuration of an operation unit according to the embodiment of the present disclosure;

FIG. 3 shows a schematic diagram which indicates a hardware configuration of a control system in the multi function peripheral according to the embodiment of the present disclosure;

FIG. 4 shows a functional block diagram of the multi function peripheral and the operation unit according to the embodiment of the present disclosure;

FIG. 5 shows a flowchart which indicates execution procedures in the embodiment of the present disclosure;

FIG. 6A shows a diagram which indicates an example of an operation screen displayed on a touch panel in the embodiment of the present disclosure, and FIG. 6B shows a diagram which indicates an example of a setting selection table in the embodiment of the present disclosure;

FIG. 7A shows a diagram which indicates an example of a setting screen displayed on a touch panel in the embodiment of the present disclosure, and FIG. 7B shows a diagram which indicates an example of a selection screen displayed on a touch panel in the embodiment of the present disclosure; and

FIG. 8A shows a diagram which indicates an example of a selection screen displayed on a touch panel in the embodiment of the present disclosure, and FIG. 8B shows a diagram which indicates an example of a list selection screen displayed on a touch panel in the embodiment of the present disclosure.

### DETAILED DESCRIPTION

Hereinafter, referencing to the attached drawings, explained is an image forming apparatus including an embodiment of an operation device of the present disclosure.

### <Image Forming Apparatus Including an Operation Device>

In the following part, explained is an image forming apparatus including an embodiment of an operation device of the present disclosure.

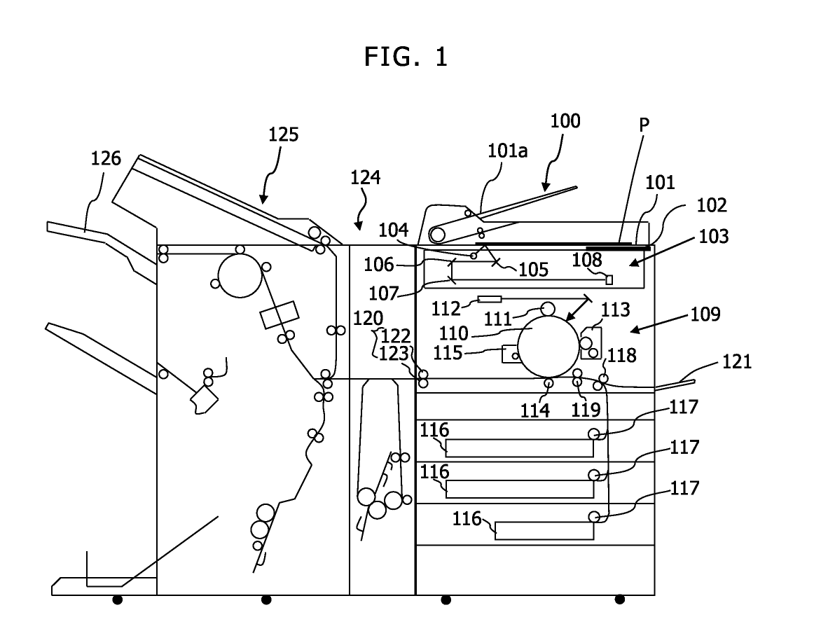

FIG. 1 shows a schematic diagram of an image forming apparatus including an embodiment of an operation device of the present disclosure. The image forming apparatus in the embodiment of the present disclosure is, for example, a printer, a scanner, a multi function peripheral which includes a printer, a copier, a scanner, a facsimile and so forth, or the like, and has a copy function, a scanner function, a facsimile function, a printer function, and so forth.

In the following part, when a user uses a copy function, an action of a multi function peripheral (MFP) 100 is briefly explained.

Firstly, a user powers on the multi function peripheral 100, puts a document P on a platen glass 101 or an automatic document feeder 101a arranged on a top surface of the multi function peripheral 100, and inputs setting conditions of the copy function using an operation unit 102 as the operation device. This operation unit 102 displays an operation screen (e.g. an initial screen) of the copy function provided by the multi function peripheral 100, and plural setting item keys of the copy function which can be selected. The setting item key is related to plural selection item keys, and a user is enabled to input a setting condition of the copy function by selecting (pressing down) a selection item key. Here a user inputs a setting condition of the copy function through the operation screen, and presses down a start key arranged on the operation unit 102 so that the multi function peripheral 100 starts a process of the copy function.

After the multi function peripheral 100 starts the process of the copy function, in an image scanning unit 103, light irradiated from a light source 104 reflects on the document P put on the platen glass 101. If the document P is put on the automatic document feeder 101a, the automatic document feeder 101a transports the document P sheet by sheet to an image scanning position of the image scanning unit 103, and light irradiated from a light source 104 reflects on the document P.

The reflected light is guided to an imaging element 108 by mirrors 105, 106, and 107. The guided light is converted to an electric signal by the image sensor element 108, and image data of the document P is generated by performing basic processes such as a correction process, an image quality process, and a compression process for the electric signal.

An image forming unit 109 is a driving unit which transfers a toner image based on the image data. The image forming unit 109 includes a photo conductor drum 110. The photo conductor drum 110 rotates at a constant speed in a predetermined direction, and in periphery of it, devices and units are arranged such as a charging device 111, an exposure unit 112, a developing device 113, a transferring device 114, and a cleaning unit 115.

The charging device 111 uniformly charges a surface of the photo conductor drum 110. The exposure unit 112 forms an electrostatic latent image on the charged surface of the photo conductor drum 110 by irradiating a laser light based on the image data. The developing device 113 forms a toner image by attaching toner to the electrostatic latent image while it is moving. The formed toner image is transferred to a recording medium (e.g. a paper sheet) by the transferring device 114. The cleaning unit 115 removes residual unnecessary toner on the surface of the photo conductor drum 110. A series of these processes is performed while the photo conductor drum 110 is rotating.

The paper sheet is fed and transported from plural paper feed cassettes 116. To transport the paper sheet, the paper sheet is fed from any one of the paper feed cassettes 116 to a transportation path by a pickup roller 117. The paper feed cassettes 116 stores respective different types of paper sheets and a paper sheet is selected and fed on the basis of setting conditions.

The paper sheet fed into the transportation path is transported inbetween the photo conductor drum 110 and the transferring device 114 by a transporting roller 118 and a registration roller 119. On the transferred paper sheet, a toner image is transferred by the transferring device 114, and then the sheet is transferred to a fuser device 120. The paper sheet transported by the transporting roller 118 may be a paper sheet transported from a manual bypass tray 121 arranged in the multi function peripheral 100.

When the paper sheet on which the toner image has been transferred passes between a heating roller and a pressuring roller in the fuser device 120, heat and pressure are applied to the toner image, and consequently, the toner image is fixed on the paper sheet. An optimal heating value of the heating roller corresponding to the paper type is set to perform fixing properly. When the toner image is fixed on the paper sheet, image forming is finished, and the paper sheet on which the toner image has been fixed is transported from the fuser device 120 to a folding device 124.

The folding device 124 performs a folding process for the transported paper sheet according to a setting condition that a user inputted. If the setting condition does not specify the folding process, the paper sheet just moves through the folding device 124.

Further, if a user inputted a setting condition of a postprocess (e.g. staple, punch, or bookbinding), the paper sheet that moves through is transported to a bookbinding device 125 to perform the postprocess. In the postprocess, for example, for bookbinding, the bookbinding device 125 performs a punch process for the plural paper sheets using an unshown punch processing unit, and a staple process for all of the paper sheets using an unshown staple processing unit.

After the postprocess, the paper sheet or a bunch of the paper sheets are piled up and stored on an output tray 126 of the bookbinding device 125. The folding device 124 and the bookbinding device 125 are called as postprocessing devices (finishers).

In the aforementioned manner, the multi function peripheral 100 provides the copy function to a user. It should be noted that other functions corresponding to the type of the multi function peripheral 100 are available such as a facsimile transmission and reception function, a scan function, and a print box function.

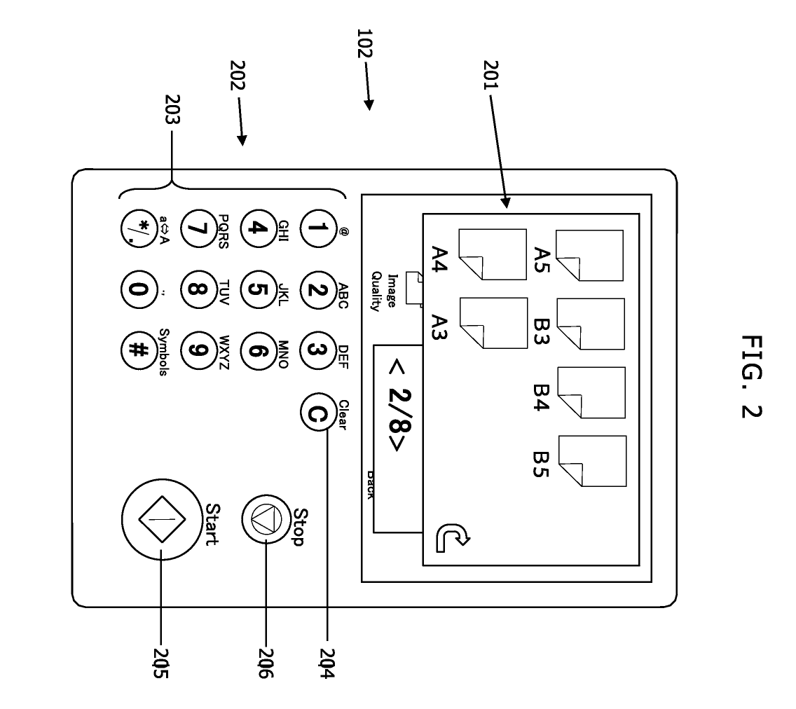

FIG. 2 shows a diagram which indicates a whole configuration of an operation unit according to the embodiment of the present disclosure. A user uses an operation unit 102 to input a setting condition such as the aforementioned setting condition for image forming and to confirm the inputted setting condition. The operation unit 102 includes a touch panel 201 (an operation panel) and an operation key 202 which are used for a user to input a setting condition.

Therefore, the touch panel 201 has a function to input a setting condition, and a function to display the setting condition. Therefore, pressing down (selecting and touching) a key on a screen displayed on the touch panel 201 inputs a setting condition corresponding to the pressed-down key.

It is assumed that the operation unit 102 in the embodiment of the present disclosure is a small-sized operation device and a display area of the touch panel 201 is relatively small.

A display unit (not shown) such as an LCD (Liquid Crystal Display) is arranged beneath the touch panel 201, and the display unit displays, for example, an operation screen such as an initial screen. When a user touches the touch panel 201, a sensor arranged under the touch panel 201 detects a touched position, and it is regarded that a key corresponding to the touched position is pressed down.

Further, the operation keys 202 are arranged near the touch panel 201, such as numeric keys 203, a clear key 204, a start key 205, and a stop key 206.

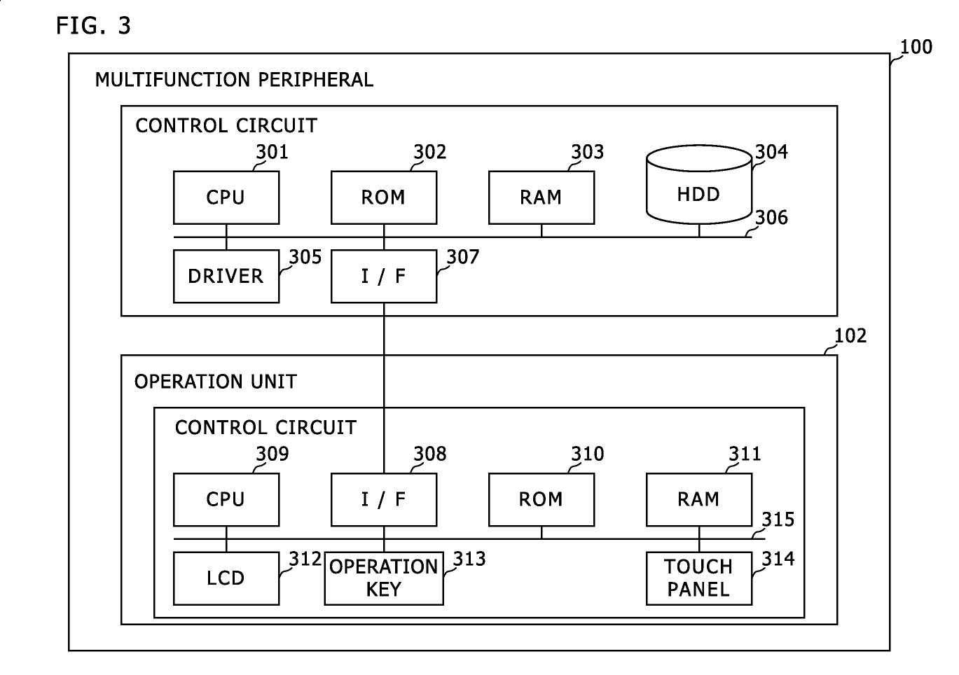

In the next part, a configuration of a control system in the multi function peripheral 100 and the operation unit 102 is explained. FIG. 3 shows a schematic diagram which indicates a hardware configuration of a control system in the multi function peripheral 100 and the operation unit 102 according to the embodiment of the present disclosure.

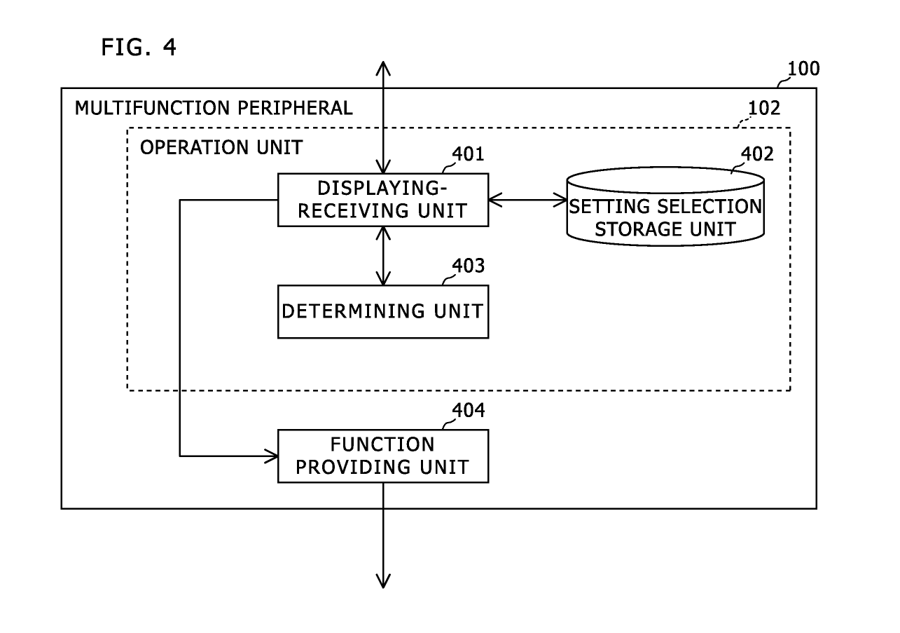

In a control circuit of the multi function peripheral 100, a CPU (Central Processing Unit) 301, a ROM (Read Only Memory) 302, a RAM (Random Access Memory) 303, an HDD (Hard Disk Drive) 304, and drivers 305 corresponding to respective driving units are connected via an internal bus 306. The CPU 301 uses the RAM 303, for example, as a work area, executes a program stored in the ROM 302, the HDD 304, or the like, transmits/receives data and instruction to/from the drivers 305 and the operation unit 102 on the basis of the execution, and controls actions of the driving units shown in FIG. 1. In addition, the CPU 301 also forms units mentioned below other than the aforementioned driving units (shown in FIG. 4) by executing a program.

Furthermore, an internal interface 307 is also connected to the internal bus 306 of the control circuit in the multi function peripheral 100, and this internal interface 307 connects a control circuits and so forth in the operation unit 102 and the control circuit of the multi function peripheral 100 to each other.

Furthermore, the control circuit of the operation unit 102 includes a CPU 309, a ROM 310, a RAM 311, an LCD 312, an operation key 313 (202), a touch panel 314 (201), and an internal interface 308 connected to an internal bus 315. When a user operates the operation key 313 or the touch panel 314, the CPU 309 transmits an instruction signal based on the operation to the control circuit of the multi function peripheral 100 via the internal interface 308. Further, the CPU 309, the ROM 310, and the RAM 311 have the same function as the aforementioned ones, and units mentioned below (shown in FIG. 4) are also formed by the execution of the program in the CPU 309. In the ROM 310, a program and data to form the units mentioned below have been stored.

### EMBODIMENT OF THE PRESENT DISCLOSURE

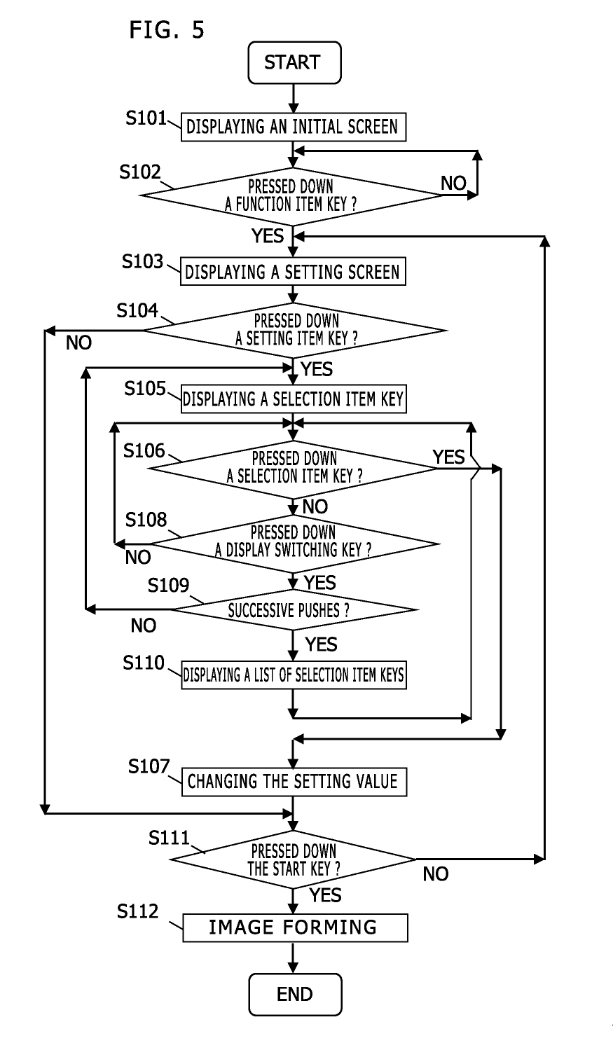

Referring to FIGS. 4 and 5, a configuration and execution procedures of the embodiment of the present disclosure are explained. FIG. 4 shows a functional block diagram of the multi function peripheral according to the embodiment of the present disclosure. Further, FIG. 5 shows a flowchart which indicates execution procedures in the embodiment of the present disclosure.

Firstly, when a user puts a document P on the platen glass 101, and powers on the multi function peripheral 100, a displaying-receiving unit 401 of the operation unit 102 of the multi function peripheral 100 sets an initial condition (initial values of respective setting items) that has been stored in a predetermined memory to a setting condition, and displays an operation screen (here an initial screen) based on the setting condition on the touch panel 201 (Step S101 in FIG. 5).

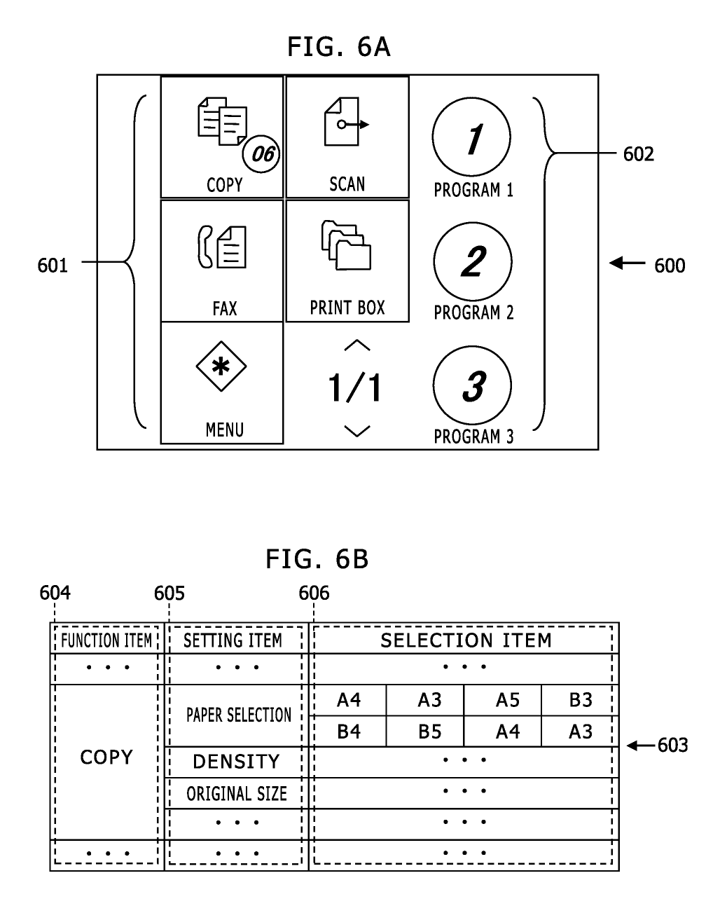

In an operation screen 600, as shown in FIG. 6A, plural function item keys 601 (e.g. “COPY” key, “FAX” key, and so forth) which indicate functions provided by the multi function peripheral 100, and program keys 602 (e.g. “1 Program 1” key and so forth) registered in advance in the multi function peripheral 100 are displayed so as to be enabled to be pressed down. Further, in the function item key 601, a function icon that expresses this function item is displayed.

If the user presses down a function item key 601 (e.g. “COPY” key) while the user is looking at the operation screen 600, then the displaying-receiving unit 401 receives this pressing down operation to the function item key 601 (YES at Step S102 in FIG. 5), and refers to a setting selection table stored in advance in a setting selection storage unit 402.

In the setting selection table 603, as shown in FIG. 6B, plural function items 604 (“COPY” and so forth), setting items 605 (“PAPER SELECTION”, “DENSITY” and so forth) corresponding to a setting condition of each one of the plural function items 604, selection items 606 (e.g. “A4” for “PAPER SELECTION” and so forth) corresponding to values of each one of the plural setting items 605 are memorized so as to be related to each other.

The displaying-receiving unit 401 refers to a setting item 605 (e.g. “PAPER SELECTION”) related to the pressed-down function item 604 (“COPY”) in the referred setting selection table 603, and displays a predetermined setting screen corresponding to the referred setting item 605 on the touch panel 201 (Step S103 in FIG. 5).

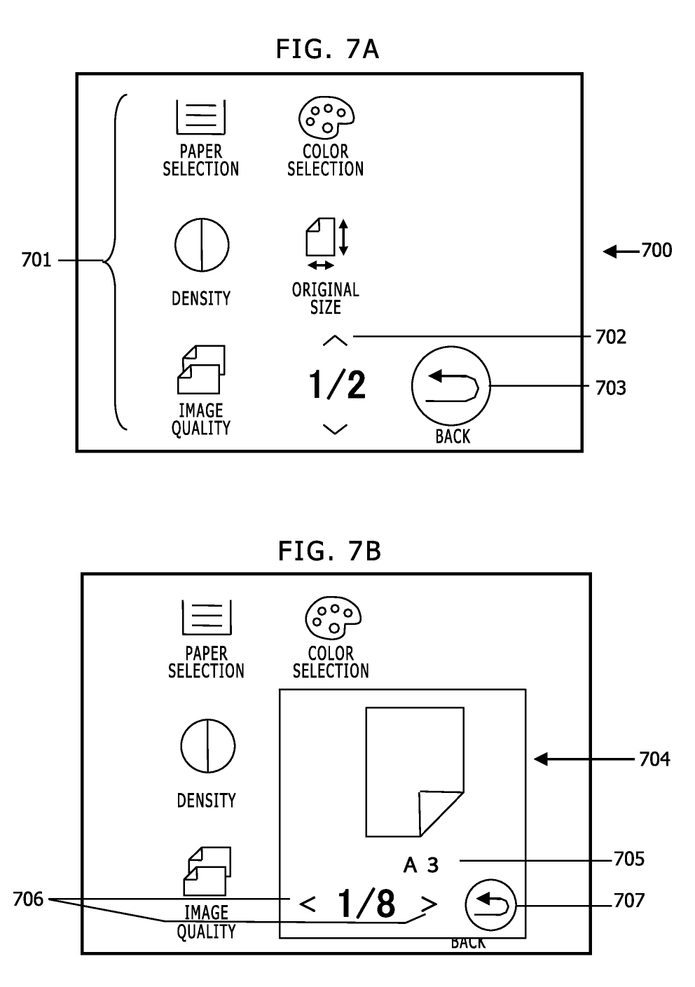

In the setting screen 700, as shown in FIG. 7A, setting item keys 701 (“PAPER SELECTION” key, “DENSITY” key and so forth) corresponding to the function item (“COPY”), a display switching key 702 (e.g. “<” key and “>” key) to switch currently displayed setting item keys 701 and display setting item keys 701 that have not been displayed, and a return key 703 are displayed so as to be enabled to be pressed down.

Further, a setting icon that expresses this setting item is displayed in the setting item key 701, and a current screen number (e.g. “1”) and the largest number of times of switching displayed item keys in the setting screen (e.g. “2”) are displayed such as “1/2” near the display switching key 702. Therefore, the user can understand the meaning of the setting item key 701 and can know that some setting item keys 701 remain.

If the user presses down a setting item key 701 (“PAPER SELECTION” key) while the user is looking at the setting screen 700, then the displaying-receiving unit 401 receives this pressing down operation to the setting item key (YES at Step S104 in FIG. 5), and refers to the aforementioned setting selection table 603.

Subsequently, in the referred setting selection table 603, the displaying-receiving unit 401 refers to the same number of one or more selection items 606 related to the pressed-down setting item 605 (“PAPER SELECTION”) in turn from the firstly memorized selection item as a displaying quantity (e.g. “1”) that has been set to the screen, and displays a selection screen corresponding to the referred selection item(s) 606 over the setting screen 700 (Step S105 in FIG. 5).

Here, in general, the displaying quantity that has been set to the screen is a number properly set on the basis of the size of the touch panel and its screen design.

In the setting screen 704, as shown in FIG. 7B, among the setting items 605, the same number of the setting item(s) 705 (e.g. “A3” key) as the aforementioned displaying quantity (“1”), a display switching key 706 (e.g. “<” key to switch to and display a previous screen, and “>” key to switch to and display a next screen) to switch a currently displayed setting item key 705 and display a setting item key that has not been displayed, and a return key 707 are displayed so as to be enabled to be pressed down.

Further, as well as in the setting screen 700, a setting icon that expresses this setting item is displayed in the setting item key 705, and a current screen number (e.g. “1”) and the largest number of times of switching displayed item keys in the selection screen (e.g. “8”) are displayed such as “1/8” near the display switching key 706.

It should be noted that even though there are many selection items, a configuration on its screen design of the selection screen 704 is applied that a predetermined number (here “1”) of selection item keys is displayed, and consequently the largest number of times of switching displayed item keys in the selection screen is large (here “8”).

Here if the user confirms a content of the displayed selection item key 705 (the setting value “A3”) and presses down this selection item key 705 while the user is looking at the selection screen 704, then the displaying-receiving unit 401 receives this pressing down operation (YES at Step S106 in FIG. 5), and changes a value of the setting item (“PAPER SELECTION”) among the set setting condition from an initial value (or a setting value if the selection item key 705 is pressed down after inputting the setting value) to the setting value (“A3”) of the setting item (Step S107 in FIG. 5). Therefore, the user is enabled to input a setting value of a setting item which the user desires.

When the displaying-receiving unit 401 finishes changing the setting value of the setting item, returns to Step S103, and displays the setting screen 700 corresponding to the setting condition on the touch panel 201 (Step S103 in FIG. 5).

On the contrary, in Step S106, if the user confirms that a selection item key 705 which the user desires is not displayed and presses down the display switching key 706 while the user is looking at the selection screen 704, then the displaying-receiving unit 401 receives this pressing down operation to the display switching key 706 (NO at Step S106 and YES at Step S108 in FIG. 5), and informs it to the determining unit 403. Upon receiving it, the determining unit 403 determines whether or not pressing down the display switching key 706 is successive pushes (Step S109 in FIG. 5).

Here, the determining unit 403 may use any method to determine or not pressing down the display switching key 706 is successive pushes, for example, a method that it is determined whether or not the user presses down the display switching key 706 again within a predetermined preset successive-push time (e.g. 1 second) from the timing when the user presses down the display switching key 706.

If it is determined that pressing down the display switching key 706 is not successive pushes, in other words, if pressing down the display switching key 706 is a single push, then the determining unit 403 informs it to the displaying-receiving unit 401. Upon receiving it, the displaying-receiving unit 401 refers to selection items 606 in the setting selection table 603, and refers to selection items other than currently displayed selection items, in other words, selection items that have not been displayed, specifically, the same number of selection items from a selection item (“A4”) next to the last referred selection item (“A3”) in turn as the aforementioned displaying quantity, and returns to Step S105, and switches the displayed selection screen to a selection screen corresponding to the referred selection item 606 and displays it (Step S105 in FIG. 5).

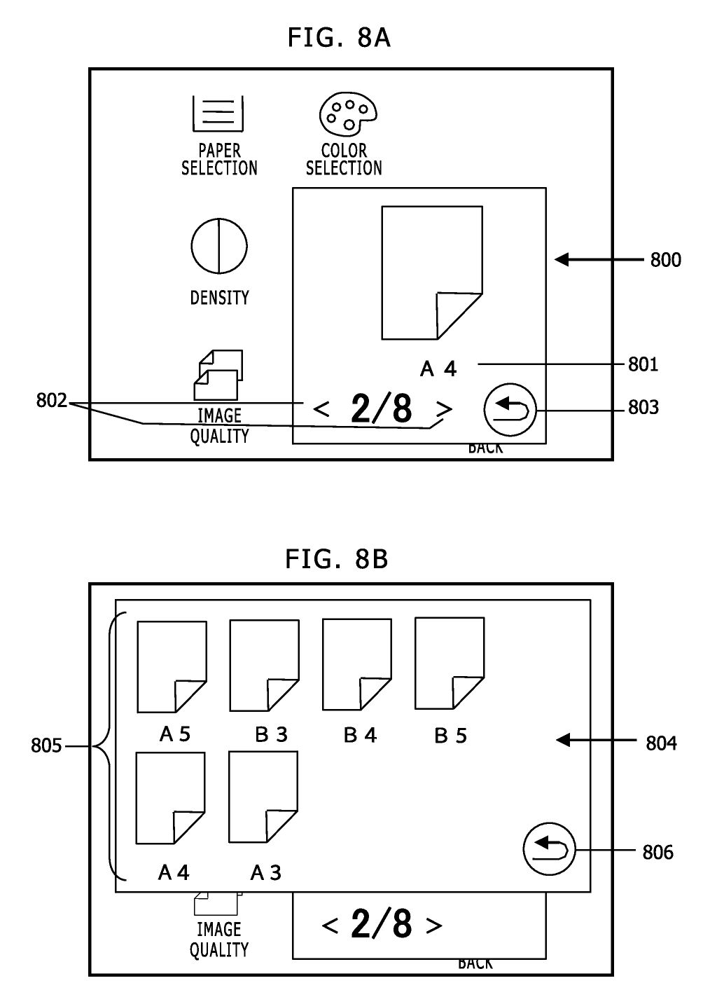

In the selection screen 800, as shown in FIG. 8A, a selection item key 801 (“A4” key) of the next selection item, a display switching key 802 (e.g. “<” key and “>” key), and a return key 803 are displayed so as to be enabled to be pressed down. Further, as well as in the setting screen 700, a current screen number (“2”) and the largest number of times of switching displayed item keys in the selection screen (“8”) are displayed such as “2/8” near the display switching key 802.

Therefore, the user is enabled to cause to display plural selection item keys by switching and displaying the selection screen 800 and press down a selection item key which the user desires.

In the aforementioned selection screens 704 and 800, even though there are many (“8”) selection items (“A4”, “A3”, and so forth) corresponding to the setting item (“PAPER SELECTION”), the displaying quantity of selection item keys are set as a small number to the selection screens 704 and 800 due to a design and so forth such as the size of the touch panel or its screen design. In such cases, the user must press down the display switching key 706 or 802 repeatedly.

In such cases, the user must successively push the display switching key 706 or 802 and consequently it causes user's irritation and inconvenience of operation. Further in the aforementioned configuration, the selection item key 705 or 801 which the user desires can not be displayed efficiently, and consequently a problem arises that the setting condition is not smoothly inputted.

Therefore, in the embodiment of the present disclosure, when the display switching key 706 or 802 is successively pushed, the following process is performed.

When the user successively pushes the display switching key 802, if in Step S109 it is determined that pressing down the display switching key 802 is successive pushes, then the determining unit 403 informs it to the displaying-receiving unit 401. Upon receiving it, the displaying-receiving unit 401 displays a list of a larger number of selection item keys that have not been displayed on the selection screens 704 and 800 than the displaying quantity that has been set to the selection screens 704 and 800 so as to be enabled to be pressed down (Step S110 to Step S106 in FIG. 5).

Here, the displaying-receiving unit 401 may use any method to display the list of the selection item keys so as to be enabled to be pressed down, for example, a method that the displaying-receiving unit 401 refers to selection items 606 in the setting selection table 603, and refers to all selection items that have not been displayed, specifically, all selection items (“A5”, “B3”, and so forth) following the last referred selection item (“A3”) in turn. Subsequently, the displaying-receiving unit 401 displays a list selection screen corresponding to all of the referred selection items over the setting screen 800.

In the list selection screen 804, as shown in FIG. 8B, all of the referred selection item keys 805 (“A5” key, “B3” key, and so forth), and a return key 806 are displayed so as to be enabled to be pressed down. Here the selection item keys 805 are moderately reduced and displayed to display a list of all of them, and reduced (small) selection icons that express the selection items are also displayed.

Therefore, if the user successively pushes the display switching key, then a list of the selection item keys that have not been displayed is displayed. Even if a selection item key which the user desires is located around the end, the user can confirm it immediately at a glance. As the result, it is possible to remove the aforementioned user's irritation and inconvenience of operation. Further, displaying the list, the user can confirm the type of the selection item keys 805 at a glance, and can efficiently seek and find a selection item key 805 which the user desires.

If the user presses down a selection item key 805 (e.g. “B3” key) while the user is looking at the list selection screen 804, as well as mentioned, the displaying-receiving unit 401 receives this pressing down operation to this selection item key 805 (YES at Step S106 in FIG. 5), and changes a value of the setting item (“PAPER SELECTION”) in the set setting condition from an initial value or the already set setting value to the setting value (here “B3”) of the selection item (Step S107 in FIG. 5). Therefore, the user is enabled to immediately input a setting value of a setting item which the user desires.

Subsequently, the displaying-receiving unit 401 returns to Step S103, and displays the setting screen 700 of the setting condition on the touch panel 201 (Step S103 in FIG. 5).

If the user presses down the start key 205 while the user is looking at the setting screen 700, then the displaying-receiving unit 401 receives this pressing down operation to the start key 205 (YES at Step S111 in FIG. 5), and informs it and the setting condition (“B3” for “PAPER SELECTION”, and so forth) to a function providing unit 404. Upon receiving them, the function providing unit 404 provides a predetermined function based on the setting condition (Step S112 in FIG. 5). In the aforementioned, the function providing unit 404 performs image forming on the basis of the setting condition. Therefore, the user is enabled to cause the multi function peripheral 100 to perform image forming on the basis of a setting condition which the user desires, and to obtain a printed matter that image forming has been performed.

As mentioned, the operation unit 102 according to the embodiment of the present disclosure includes the determining unit 403, and the displaying-receiving unit 401. The determining unit 403 determines whether or not pressing down the display switching key 706 or 802 is successive pushes when the display switching key 706 or 802 is pressed down; and the display switching key 706 or 802 is a key to switch currently displayed selection item keys 705 and 801 on the selection screens 704 and 800 and display item keys that have not been displayed on the selection screens 704 and 800. The displaying-receiving unit 401 displays a list of a larger number of selection item keys 705 and 801 that have not been displayed on the selection screens 704 and 800 than a number (i.e. the aforementioned displaying quantity) that has been set to the selection screens 704 and 800 so as to be enabled to be pressed down if the determining unit 403 determines that pressing down the display switching key 706 or 802 is successive pushes.

Therefore, a user is enabled to efficiently confirm plural selection item keys 705 and 801 when the user confirms the selection item keys 705 and 801 with switching displayed keys.

The description of the present disclosure has been presented for purposes of illustration and description, and is not intended to be exhaustive or limited to the disclosure.

In the aforementioned embodiment of the present disclosure, if the return key 703, 707, 803, or 806 is pressed down, then the previously displayed screen is displayed again.

Further, the aforementioned embodiment of the present disclosure is configured to include the selection item keys 705 and 801 in the displayed list. Alternatively, another configuration may be applied. For example, the setting item keys and the function item keys may be included in the displayed list.

Furthermore, the aforementioned embodiment of the present disclosure is applied to the copy function as an example, but it is not limited to the copy function. For example, it may be applied to setting items and selection items in another function such as a scanner function, a facsimile function, or a printer function.

Furthermore, in the aforementioned embodiment of the present disclosure, the displaying-receiving unit 401 is configured to reduce and display a list with a scale so as to include all of the selection item keys 805 in the selection screen 704 or 800. Alternatively, another configuration may be applied. For example, the displaying-receiving unit 401 may be configured to display a list in which only keys of all of the selection item keys 805 are arranged in parallel.

Furthermore, in the aforementioned embodiment of the present disclosure, the displaying-receiving unit 401 is configured to display a list of all selection item keys when the display switching key 706 for whichever type of the selection item keys 705 and 801 is successively pushed. Alternatively, another configuration may be applied. For example, the displaying-receiving unit 401 may be configured to display a list of all selection item keys when the display switching key 706 is successively pushed to switch displaying the selection item keys, if the number of the selection item keys is greater than a predetermined number (e.g. 5); for example, “PAPER SELECTION”, “DENSITY”, “ORIGINAL SIZE” and so forth in the copy function.

Furthermore, in the aforementioned embodiment of the present disclosure, a program may be stored in a recording medium to form the aforementioned units in the operation unit 102, and a configuration may be available in which the recording medium may be provided. In this configuration, the operation unit 102 reads out the program and forms the aforementioned units. In such a case, the program itself read out from the recording medium brings actions and advantages of the present disclosure. Further, it is possible to provide a method in which a step executed by the aforementioned unit is stored in a hard disk.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

What is claimed is:

1. An operation device that displays a predetermined number of item keys among plural item keys on a predetermined screen so as to be enabled to be pressed down, comprising:
a determining unit configured to determine whether or not pressing down a display switching key to switch currently displayed item keys on the screen and display item keys that have not been displayed on the screen is successive pushes when the display switching key is pressed down; and
a displaying-receiving unit configured to display a list of a larger number of item keys that have not been displayed on the screen than a number that has been set to the screen so as to be enabled to be pressed down if the determining unit determines that pressing down the display switching key is successive pushes.

2. The operation device according to claim 1, wherein:
the displaying-receiving unit is further configured to display a same number of item keys that have not been displayed on the screen as the number that has been set to the screen so as to be enabled to be pressed down if the determining unit determines that pressing down the display switching key is not successive pushes.

3. The operation device according to claim 1, wherein:
the displaying-receiving unit is further configured to display a list of all item keys that have not been displayed on the screen so as to be enabled to be pressed down if the determining unit determines that pressing down the display switching key is successive pushes.

4. An image forming apparatus, comprising:
an operation device configured to display a predetermined number of item keys among plural item keys on a predetermined screen so as to be enabled to be pressed down;
wherein the operation device comprises:
a determining unit configured to determine whether or not pressing down a display switching key to switch currently displayed item keys on the screen and display item keys that have not been displayed on the screen is successive pushes when the display switching key is pressed down; and
a displaying-receiving unit configured to display a list of a larger number of item keys that have not been displayed on the screen than a number that has been set to the screen so as to be enabled to be pressed down if the determining unit determines that pressing down the display switching key is successive pushes.

5. An operation method that displays a predetermined number of item keys among plural item keys on a predetermined screen so as to be enabled to be pressed down, comprising the steps of:
determining whether or not pressing down a display switching key to switch currently displayed item keys on the screen and display item keys that have not been displayed on the screen is successive pushes when the display switching key is pressed down; and
displaying a list of a larger number of item keys that have not been displayed on the screen than a number that has been set to the screen so as to be enabled to be pressed down if it is determined that pressing down the display switching key is successive pushes.
